(19) United States
(12) Patent Application Publication
(10) Pub. No.: US 2009/0080419 A1
(43) Pub. Date: Mar. 26, 2009

(54) Providing consistent manageability interface to a management controller for local and remote connections

(76) Inventor: Patrick G. Kutch, Beaverton, OR (US)

Correspondence Address: Caven & Aghevli LLC;c/o CPA Global, P.O. BOX 52050, MINNEAPOLIS, MN, 55402, US

(21) Appl. No.: 11/904,164

(22) Filed: Sep. 26, 2007

(51) Int. Cl. H04L 12/56

(52) U.S. Cl. 370/389; 370/419; 709/223; 710/306

(57) ABSTRACT

Methods and apparatus relating to providing a manageability interface to a management controller for local and/or remote connections are described. In one embodiment, a network adapter of a host computing system may forward a packet transmitted by the host computing system to a management controller based on a determination that the packet is a manageability packet. Other embodiments are also disclosed.

### BACKGROUND

The present disclosure generally relates to the field of electronics. More particularly, an embodiment of the invention generally relates to providing a manageability interface to a management controller (MC) for local and/or remote connections.

Networking has become an integral part of computer systems. However, as networks grow in size and complexity, their management becomes increasingly more difficult in part due to remoteness of some of the network devices. As a result, the use of remote manageability is increasing at a steady rate. However, some of the current approaches may need to utilize a separate interface for remote manageability versus local manageability.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures may indicate similar items.

FIG. 1 illustrates various components of an embodiment of a networking environment, which may be utilized to implement various embodiments discussed herein.

FIG. 2 illustrates a block diagram of an embodiment of a computing system, which may be utilized to implement some embodiments discussed herein.

FIG. 3 illustrates a flow diagram of method according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

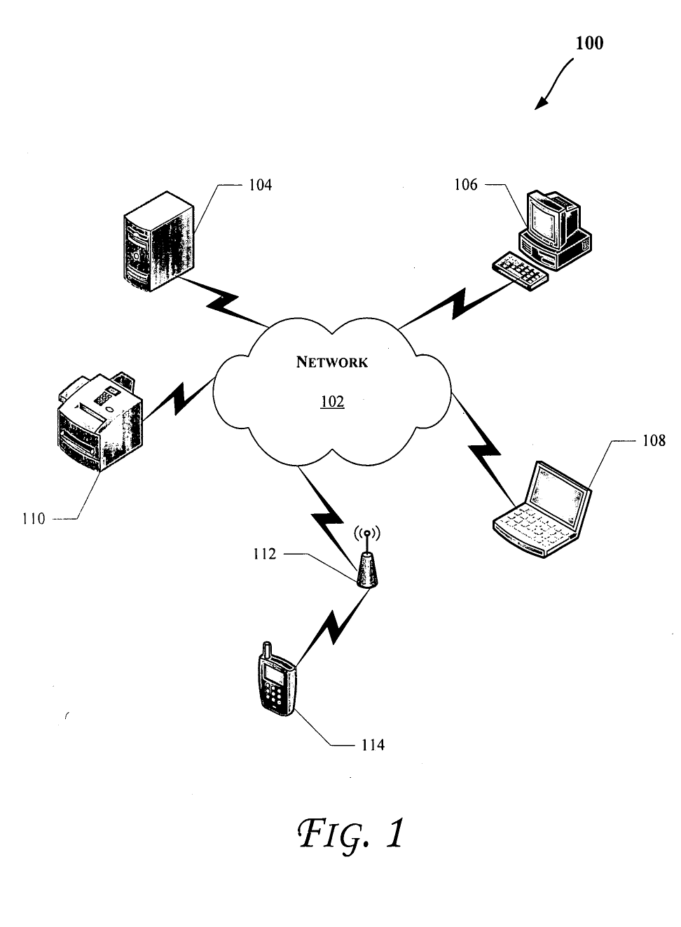

Some of the embodiments discussed herein may provide a manageability interface to a management controller (MC) for local and/or remote connections. In one embodiment, a network adapter of a host computing system may forward a packet transmitted by the host computing system to a management controller based on a determination that the packet is a manageability packet. In general, incoming network packets may be analyzed based upon a number of possible filters as will be further discussed herein, e.g., with reference to FIGS. 1-3. If manageability is enabled and an incoming packet is identified as a manageability packet, it is routed to the management controller for further processing.

FIG. 1 illustrates various components of an embodiment of a networking environment 100, which may be utilized to implement various embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a wireless access point 112, a personal digital assistant or smart phone 114, a rack-mounted computing system (not shown), etc. The network 102 may be any type of a computer network including an intranet, the Internet, and/or combinations thereof.

The devices 104-114 may be coupled to the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any type of communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) or external network interface devices (e.g., having a separate physical enclosure and/or power supply than the computing system to which it is coupled) such as a network interface card (NIC).

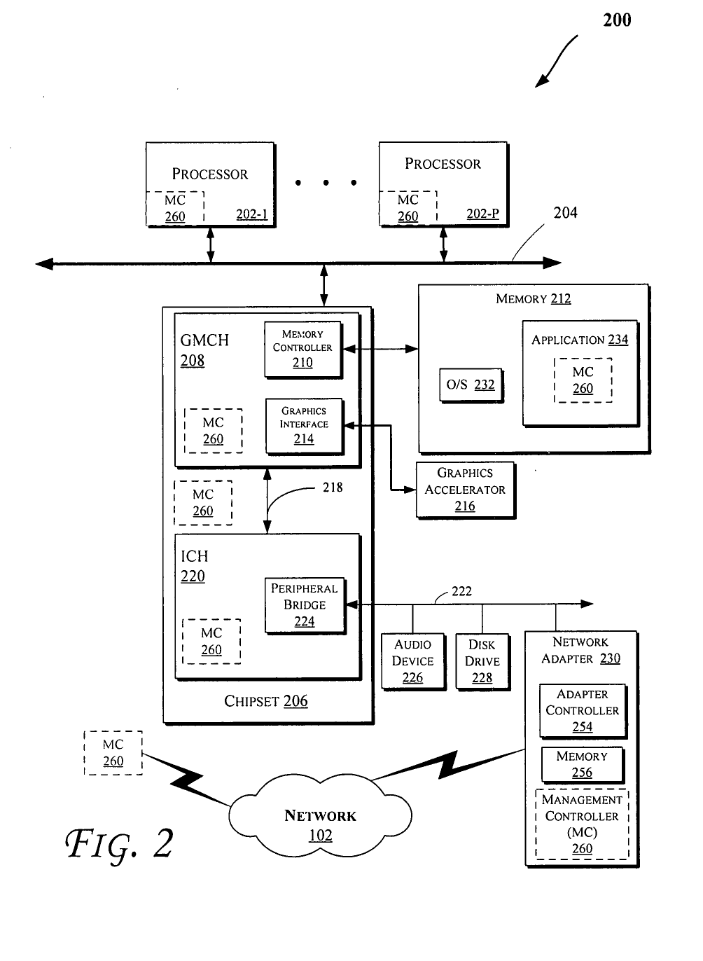

FIG. 2 illustrates a block diagram of a computing system 200 in accordance with an embodiment of the invention. The computing system 200 may include one or more central processing unit(s) (CPUs) or processors 202-1 through 202-P (which may be referred to herein as “processors 202” or “processor 202”). The processors 202 may communicate via an interconnection network (or bus) 204. The processors 202 may include a general purpose processor, a network processor (that processes data communicated over the computer network 102), or other types of a processor (including a reduced instruction set computer (RISC) processor or a complex instruction set computer (CISC)). Moreover, the processors 202 may have a single or multiple core design. The processors 202 with a multiple core design may integrate different types of processor cores on the same integrated circuit (IC) die. Also, the processors 202 with a multiple core design may be implemented as symmetrical or asymmetrical multiprocessors. In an embodiment, various operations discussed herein, e.g., with reference to FIGS. 1-3 may be performed by one or more components of the system 200.

A chipset 206 may also communicate with the interconnection network 204. The chipset 206 may include a graphics memory control hub (GMCH) 208. The GMCH 208 may include a memory controller 210 that communicates with a memory 212. The memory 212 may store data, including sequences of instructions that are executed by the processor 202, or any other device included in the computing system 200. In one embodiment of the invention, the memory 212 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 204, such as multiple CPUs and/or multiple system memories.

The GMCH 208 may also include a graphics interface 214 that communicates with a graphics accelerator 216. In one embodiment of the invention, the graphics interface 214 may communicate with the graphics accelerator 216 via an accelerated graphics port (AGP). In an embodiment of the invention, a display (such as a flat panel display, a cathode ray tube (CRT), a projection screen, etc.) may communicate with the graphics interface 214 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 218 may allow the GMCH 208 and an input/output control hub (ICH) 220 to communicate. The ICH 220 may provide an interface to I/O devices that communicate with the computing system 200. The ICH 220 may communicate with a bus 222 through a peripheral bridge (or controller) 224, such as a peripheral component interconnect (PCI) bridge, a universal serial bus (USB) controller, or other types of peripheral bridges or controllers. The bridge 224 may provide a data path between the processor 202 and peripheral devices. Other types of topologies may be utilized. Also, multiple buses may communicate with the ICH 220, e.g., through multiple bridges or controllers. Moreover, other peripherals in communication with the ICH 220 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 222 may communicate with an audio device 226, one or more disk drive(s) 228, and one or more network interface device(s) 230 (which is in communication with the computer network 102 and may comply with one or more of the various types of communication protocols discussed with reference to FIG. 1). Other devices may communicate via the bus 222. Also, various components (such as the network interface device 230) may communicate with the GMCH 208 in some embodiments of the invention. In addition, the processor 202 and the GMCH 208 may be combined to form a single chip. Furthermore, the graphics accelerator 216 may be included within the GMCH 208 in other embodiments of the invention.

Furthermore, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 200 may be arranged in a point-to-point (PtP) configuration. For example, processors, memory, and/or input/output devices may be interconnected by a number of point-to-point interfaces.

As illustrated in FIG. 2, the memory 212 may include one or more of an operating system(s) (O/S) 232 or application(s) 234. The memory 212 may also store one or more device driver(s), packet buffers, descriptors, protocol driver(s), etc. (not shown) to facilitate communication over the network 102. Programs and/or data in the memory 212 may be swapped into the disk drive 228 as part of memory management operations. The application(s) 234 may execute (on the processor(s) 202) to communicate one or more packets with one or more computing devices coupled to the network 102 (such as the devices 104-114 of FIG. 1). In an embodiment, a packet may be a sequence of one or more symbols and/or values that may be encoded by one or more electrical signals transmitted from at least one sender to at least on receiver (e.g., over a network such as the network 102). For example, each packet may include a header that includes various information which may be utilized in routing and/or processing the packet, such as a source address, a destination address, packet type, etc. Each packet may also have a payload that includes the raw data (or content) the packet is transferring between various computing devices (e.g., the devices 104-114 of FIG. 1) over a computer network (such as the network 102).

In an embodiment, the application 234 may utilize the O/S 232 to communicate with various components of the system 200, e.g., through a device driver. Hence, the device driver may include network adapter (230) specific commands to provide a communication interface between the O/S 232 and the network adapter 230. For example, the application 234 may include a network management application that may support various interfaces such as Intelligent Platform Management Interface (IPMI), Alert Standard Format (ASF), Intel® Active Management Technology (iAMT®), etc. to manage various aspects of network management (such as management of the network 102).

Furthermore, in some embodiments, the network adapter 230 may include a (network) protocol layer for implementing the physical communication layer to send and receive network packets to and from remote devices over the network 102. The network 102 may include any type of computer network such as those discussed with reference to FIG. 1. The network adapter 230 may further include a DMA engine, which may write packets to buffers assigned to available descriptors in the memory 212. Additionally, the network adapter 230 may include a network adapter controller 254, which may include hardware (e.g., logic circuitry) and/or a programmable processor to perform adapter related operations. In an embodiment, the adapter controller 254 may be a MAC (media access control) component. The network adapter 230 may further include a memory 256, such as any type of volatile/nonvolatile memory, and may include one or more cache(s).

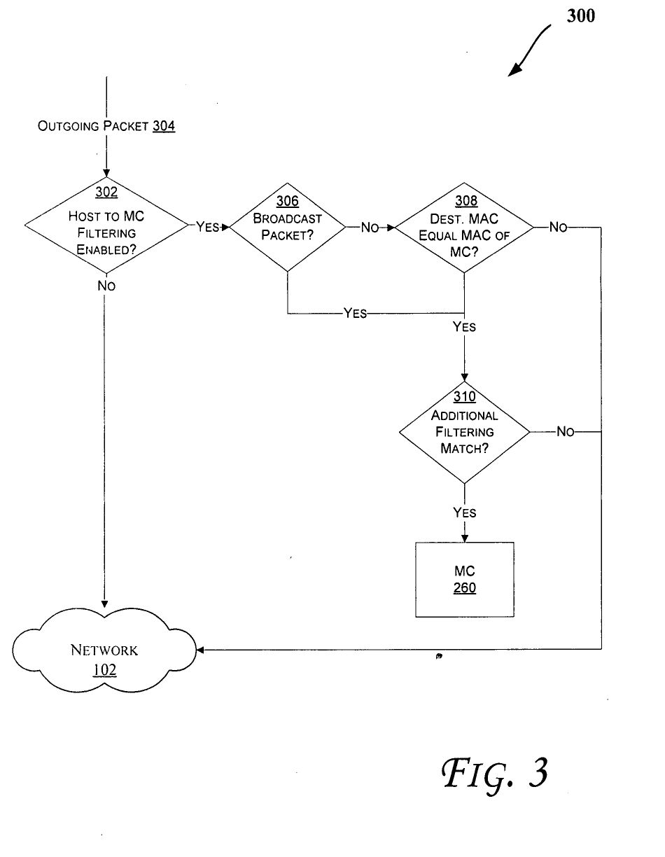

As shown in FIG. 2, the network adapter 230 may include a management controller (MC) 260 (which may be implemented as hardware, software, or some combination thereof) to receive packets identified as manageability packets from the network 102 and/or component(s) of the system 200, as will be further discussed herein with reference to FIG. 3. In an embodiment, the MC 260 may be provided in one or more locations within the system 200 such as shown in FIG. 2 (including, for example, as a software application (234) such as the network management application discussed herein), but the MC 260 may be provided elsewhere in the system 200. Also, the MC 260 may be provided outside of the system 200 (e.g., within another computing device such as devices 104-114 discussed with reference to FIG. 1). Further, more than one MC 260 may be utilized in accordance with some embodiments.

FIG. 3 illustrates a flow diagram of a method 300 to provide a consistent manageability interface, according to an embodiment. For example, the method 300 may be used to provide a consistent manageability interface to a management controller (e.g., MC 260 of FIG. 2) for both local and remote connections. In some embodiments, one or more of the components discussed with reference to FIG. 2 may be used to perform one or more of the operations of method 300.

In general, incoming network packets (e.g., from network 102 into the network adapter 230) may be analyzed based upon a number of possible filters such as MAC address, Virtual Local Area Network (VLAN), port number etc. If manageability is enabled and an incoming packet is identified as a manageability packet, it is routed to the management controller (e.g., MC 260) for further processing. Local management of the system may also interact with the management controller; however, this may be accomplished using a different interface to the MC 260 than that used remotely over a network. Some of such interfaces may be KCS (Keyboard Controller Style), HECI (Host Embedded Controller Interface) and BT (Block Transfer) in some implementations. The disparity between the remote (network) and local interfaces to a MC may result in a management application having to communicate through different local and remote interfaces, which may be more complex or costly to implement. Using the techniques discussed herein though, a management application may use the same network interface for manageability, even locally from the host computing system it is managing.

Referring to FIGS. 1-3, at an operation 302 (e.g., instead of routing all outgoing network traffic, for example, outgoing packet 304, to the network 102, whether originating from the host computing system (e.g., from the O/S 232) or the MC 260), it may be determined whether host to MC filtering is enabled. If not enabled, the outgoing packet 304 is passed to the network 102. Otherwise, at an operation 306, it may be determined whether the outgoing packet 304 is a broadcast packet. If the outgoing packet 304 is not a broadcast packet, an operation 308 may analyze the outgoing packet 304 (e.g., the header of the outgoing packet 304 in one embodiment) to determine whether the outgoing packet 304 is destined for the MC 260 (e.g., by comparing the destination MAC of the outgoing packet 304 with the MAC address the MC 260). If not destined for the MC 260, the outgoing packet 304 is passed to the network 102.

If the outgoing packet 304 is a broadcast packet or it is destined for the MC 260, it is further checked against any additional filtering at operation 310 (e.g., to determine whether the outgoing packet 304 is a manageability packet). For example, the MC 260 may receive ARP (Address Resolution Protocol) requests so that it may examine them and perform an ARP response if the incoming request is for the Internet Protocol (IP) address the MC 260. In some embodiments, the IP address and/or the MAC address of the MC 260 may be assigned by the MC 260 itself. Further, in some embodiments, the filtering match performed at operation 310 may include such things as VLAN, a specific IP or MAC address, port numbers, combinations thereof, etc. (e.g., to determine whether the outgoing packet 304 is a manageability packet). If there is no match at operation 310, the outgoing packet 304 may be passed to the network 102. If there is a match at operation 310 (e.g., it is determined that the outgoing packet 304 is a manageability packet), the outgoing packet 304 may be passed to the MC 260.

An example configuration might be that the MC 260 and the host share a MAC address and have a different IP address. In such a case the MC 260 may enable the host to MC feature, configure the MAC address to filter on (in this case the system MAC address) and finally configure a specific IP address to filter on. Additionally, the MC may further filter on one or more specific port numbers, such as HTTP (Hypertext Transfer Protocol) or RMCP (Remote Management Control Protocol) traffic, so that specific types of packets are passed to the MC 260, for example.

Some of the embodiments discussed herein may allow manageability software designers to focus on design and development for one type of interface to the MC 260 and network. Such a capability may increase security by applying network authentication to local connections, for example. Also, development time may be reduced, as a single interface may be designed and tested to the MC 260.

Furthermore, in some embodiments, one or more of the operations 302, 306, 308, and/or 310 may be performed be the network adapter 230 (e.g., the adapter controller 254 may perform one or more of the operations 302, 306, 308, and/or 310, for example, by accessing the memory 256). For example, the memory 256 may store one or more bits of data to indicate whether host to MC filtering is enabled, the outgoing packet 304 (e.g., including the packet payload and/or header), an address (e.g., MAC or IP address) of the MC 260, filtering information, etc. and the adapter controller 254 may access the information stored in the memory 256 to perform one or more of the operations 302, 306, 308, and/or 310. In some embodiments, the one or more bits of data that indicate whether host to MC filtering is enabled may be stored in the memory 256 and other memory devices discussed with reference to FIG. 2 (such as the memory 212). Hence, in some embodiments, these bits may be stored in the memory 256 alone or in multiple locations at the same time.

In various embodiments of the invention, the operations discussed herein, e.g., with reference to FIGS. 1-3, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed with respect to FIG. 2.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A network adapter comprising:
a memory to store one or more bits of data to indicate whether host to management controller filtering is enabled; and
an adapter controller to forward a packet transmitted by a host computing system to a management controller based on the one or more stored bits of data and a determination that the packet is a manageability packet,
wherein the host computing system comprises a host memory to store a management application that transmits the packet to the network adapter and wherein the management application transmits the packet to the network adapter through a same manageability interface as packets received by the network adapter from a computer network.

2. The network adapter of claim 1, further comprising a chipset to couple the network adapter and the host computing system through a peripheral bridge.

3. The network adapter of claim 1, wherein the host memory is to store an operating system that causes the packet to be transmitted to the network adapter.

4. The network adapter of claim 1, wherein the memory is to store an address associated with the management controller and wherein the adapter controller forwards the packet to the address after a determination that the packet is destined to the address.

5. The network adapter of claim 1, wherein the network adapter comprises the management controller.

6. The network adapter of claim 1, wherein the network adapter is coupled to a computer network to communicate with one or more computing devices, wherein at least one of the one or more computing devices coupled to the computer network comprise the management controller.

7. A method comprising:
in response to a determination that host to management controller filtering is enabled, determining whether a packet received from a host computing system is a manageability packet; and
forwarding the packet to the management controller after determining that the packet is a manageability packet.

8. The method of claim 7, further comprising determining whether the packet is a broadcast packet.

9. The method of claim 7, further comprising determining whether a destination address of the packet matches an address associated with the management controller.

10. The method of claim 7, further comprising forwarding the packet to a computer network if the packet is not a manageability packet.

11. The method of claim 7, wherein determining that the packet is a manageability packet comprises applying one or more filters to the packet.

12. The method of claim 11, wherein the one or more filters are based on a Virtual Local Area Network (VLAN), an address, a port number, or combinations thereof.
